(19) United States
(12) Patent Application Publication
(10) Pub. No.: US 2007/0002356 A1
(43) Pub. Date: Jan. 4, 2007

(54) Image forming method and system using XHTML-Print data

(75) Inventor: Jun-hyung Ha, Seoul (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/471,498

(22) Filed: Jun. 21, 2006

(30) Foreign Application Priority Data
Jul. 4, 2005 (KR) 10-2005-0059718

(51) Int. Cl. G06F 3/12

(52) U.S. Cl. 358/1.13; 358/1.15

(57) ABSTRACT

An image forming method and system using extensible hypertext markup language (XHTML)-Print data in an image forming system having an image forming apparatus printing an image, and a device connected to the image forming apparatus includes setting layout information of an image, generating HXTML-Print data from the set layout information, and storing the XHTML-Print data in a storage unit. According to the method and system, by writing layout information of the image in an XHTML-Print language and storing the information, when an identical image to the image is to be printed in the identical layout to the set layout information, the image forming system can print the image by using the XHTML-Print data of the stored layout information without resetting the layout information.

### CROSS-REFERENCE TO RELATED APPLICATIONS

This application claims the benefit of Korean Patent Application No. 10-2005-0059718, filed on Jul. 4, 2005, in the Korean Intellectual Property Office, the disclosure of which is incorporated herein in its entirety by reference.

### BACKGROUND OF THE INVENTION

1. Field of the Invention

The present general inventive concept relates to an image processing system, and more particularly, to an image forming method and system using extensible hypertext markup language (XHTML)-Print data, which is generated from layout information of an image and stored, and parsed when an image is desired to be printed in an identical layout, such that the image is printed according to the parsed XHTML-Print data.

2. Description of the Related Art

In a conventional image forming method, a host should convert print data into a page description language (PLD) by using a printer driver, and transmits the converted print data to a printer. The printer receives the print data through an input/output (I/O) interface. In the print data received through the I/O interface, a printing job language (PJL) command is parsed by a PJL parser. With the parsed PJL command, a type of emulation of a print data is determined and executed, and the emulated print data is output by a print engine.

If the image data is desired to be printed in a variety of layout shapes, while confirming a layout of the image by using a preview function through a monitor of the host, the user sets layout information through a user interface unit.

The host transmits the set layout information to the printer, and the printer prints the image data according to the set layout information. However, once it is used, this layout information is deleted and thereafter if the image data is desired to be printed in the same layout, the layout information should be set again whenever processing the print data. Accordingly, it is needed to store the layout information to be used later when the image data is desired to be printed. Also, when the layout information is stored, it is needed to store the layout information in a general-purpose language that can be used in other platform printers.

### SUMMARY OF THE INVENTION

The present general inventive concept provides an image forming method and system using extensible hypertext markup language (XHTML)-Print data, by which layout information of an image is written in an XHTML-Print language and stored, and thereafter when an image is desired to be printed in an identical layout, the XHTML-Print data is parsed and the image is printed.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an image forming method using extensible hypertext markup language (XHTML)-Print data in an image forming system having an image forming apparatus printing an image, and a device connected to the image forming apparatus, the image forming method including setting layout information of an image, generating HXTML-Print data from the set layout information, and storing the XHTML-Print data in a storage unit. The method may further include after the storing of the XHTML-Print data, parsing the XHTML-Print data and printing the image according to the parsed XHTML-Print data. The layout information may include at least one of position information of each image to be laid out in one page, image size information, print paper information, font information, and space information.

The foregoing and/or other aspects of the present general inventive concept may also be achieved by providing an image forming method using XHTML-Print data in an image forming system having an image forming apparatus printing an image, and a device connected to the image forming apparatus, the image forming method including setting layout information of an image, generating HXTML-Print data from the set layout information, storing the XHTML-Print data in a storage unit, and transmitting the XHTML-Print data stored in the storage unit to another device through a network.

The foregoing and/or other aspects of the present general inventive concept may also be achieved by providing an image forming system using extensible hypertext markup language (XHTML)-Print data, the image forming system having an image forming apparatus printing an image, and a device connected to the image forming apparatus, wherein the device includes a user interface unit to set layout information of an image, and a control unit to lay out the image according to the layout information, to generate XHTML-Print data from the layout information, to read and parse the XHTML-Print data, and to transmit the parsed XHTML-Print data to the image forming apparatus, and the image forming system further includes a storage unit to store the generated XHTML-Print data.

The foregoing and/or other aspects of the present general inventive concept may also be achieved by providing an image forming system using extensible hypertext markup language (XHTML)-Print data, the image forming system having an image forming apparatus printing an image, and a device connected to the image forming apparatus, wherein the device includes a user interface unit to set layout information of an image, a control unit lay out the image according to the layout information, to generate XHTML-Print data from the layout information, to read and parse the XHTML-Print data, and to transmit the parsed XHTML-Print data to the image forming apparatus, a storage unit to store the generation XHTML-Print data and an input/output interface unit to transmit the XHTML-Print data to another device through a network.

The foregoing and/or other aspects of the present general inventive concept may also be achieved by providing an image forming system including a storage unit, and a control unit to control the storage unit to store XHTML-Print data corresponding to layout information on a first image, and to read the stored XHTML-Print data from the storage unit to form a second image according to the read XHTML-Print data.

The foregoing and/or other aspects of the present general inventive concept may also be achieved by providing an image forming system including a user interface unit to set layout information, an XHTML-Print data processing unit to generate the XHTML-Print data according to the set layout information, a storage unit, a print unit, and a control unit to control the print unit a first image according to the layout information, to generate XHTML-Print data using an XHTML language from the layout information so that a first image is printed according to the layout information, to store the XHTML-Print data in the storage unit, and to output the XHTML-Print data to an external device, to read and parse the XHTML-Print data, and to control the print unit to print a second image according to the parsed XHTML-Print data.

The foregoing and/or other aspects of the present general inventive concept may also be achieved by providing image forming system including a first device and a second device, the first device having a user interface unit to set layout information, an XHTML-Print data processing unit to generate the XHTML-Print data according to the set layout information, a storage unit, and a control unit to generate XHTML-Print data using an XHTML language from the layout information so that a first image is formed according to the XHTML-Print data, to store the XHTML-Print data in the storage unit, and to output the XHTML-Print data, and the second device having a second storage unit, a print unit, and a second control unit to receive the output XHTML-Print data from the first device, to control the second storage unit to store the XHTML-Print data, to read and parse the XHTML-Print data, and to control the print unit to print a second image according to the parsed XHTML-Print data.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1A is a block diagram illustrating an image forming system using XHTML-Print data according to an embodiment of the present general inventive concept;

FIG. 1B is a block diagram illustrating an image forming system using XHTML-Print data according to an embodiment of the present general inventive concept;

FIG. 2 is a flowchart illustrating an image forming method using XHTML-Print data according to an embodiment of the present general inventive concept;

FIG. 3 is a flowchart illustrating an image forming method using XHTML-Print data according to an embodiment of the present general inventive concept;

FIGS. 4A through 4D are diagrams illustrating layout results of images; and

FIG. 5 a view illustrating XHTML-Print data generated in an XHTML-Print data generation unit in FIG. 1A.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

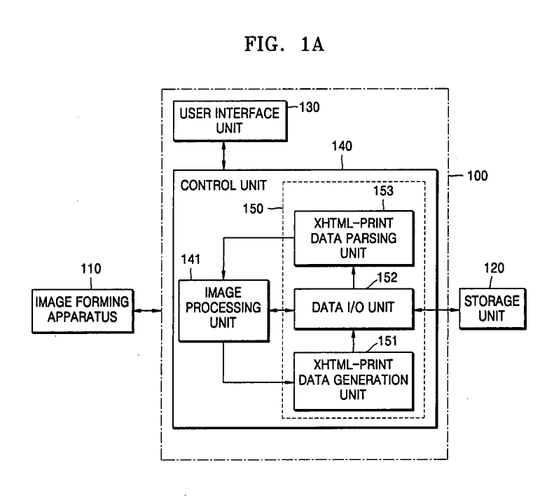

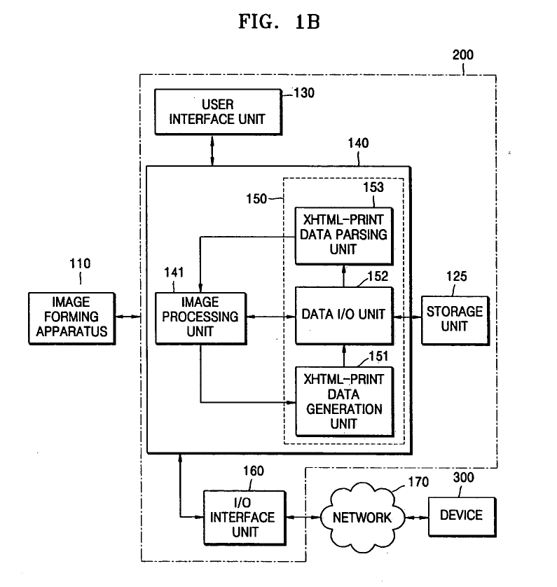

FIG. 1A is a schematic block diagram illustrating an image forming system using XHTML-Print data according to an embodiment of the present general inventive concept.

An XHTML language is an application of an extensible markup language (XML) and is obtained by formulating hypertext markup language (HTML), for example, version 4. Among markup language corresponding to the XHTML, XHTML-Print is a language designed to express image forming data provided from a mobile device to an image forming apparatus, and is a next-generation page description language (PDL) mentioned in universal plug and play (UPnP), mobile & image printing consortium (MIPC), and digital living network alliance (DLNA).

Referring to FIG. 1A, the image forming system is formed with a device 100, an image forming apparatus 110 having a printing unit to print an image on a printing medium, and a storage unit 120. Here, the device 100 can be a wireless communication device that can communicate through a wireless network, including a mobile phone, a personal digital assistant (PDA), and a wired communication device that can communicate through a wired network.

The device 100 includes a user interface unit 130 and a control unit 140.

A user selects a plurality of images to be printed in one page through the user interface unit 130 and sets layout information including position information of one or more selected ones of the images, image size information, print paper information, font information (when there is text data), and space information. An image selected through the user interface unit 130 by the user can be formed with a plurality of pages.

The user interface unit 130 displays through a preview function one or more of the plurality of images selected by the user according to the layout information set by the user. The user interface unit 130 outputs information on the images selected by the user and the layout information of the selected images to the control unit 140. The user can select one image layout page among image layout pages having a plurality of image layouts. In another method, the user can directly lay out the plurality of images by using an input key (not shown) or a mouse (not shown) of the user interface unit 130.

The control unit 140 performs an overall control operation of the device 100, and includes an image processing unit 141 and an XHTML-Print data processing unit 150.

The image processing unit 141 lays out the plurality of images in one page according to the layout information of the images set by the user. The image processing unit 141 lays out a plurality of images in one image layout page selected by the user among the image layout pages having a variety of image layouts, and displays the laid-out result through the user interface unit 130.

The XHTML-Print data processing unit 150 generates the XHTML-Print data from the layout information, and parses the XHTML-Print data. The XHTML-Print data processing unit 150 includes an XHTML-Print data generation unit 151, a data input/output (I/O) unit 152, and an XHTML-Print data parsing unit 153.

The XHTML-Print data generation unit 151 generates the XHTML-Print data from the image information and the layout information of images received from the control unit 140. The image and layout information includes the position information of each image to be laid out in one page, and the image size information. The image size information can be information indicating a ratio of enlargement and/or reduction to original image data. The XHTML-Print data generation unit 151 outputs the generated XHTML-Print data to the data I/O unit 152.

The data I/O unit 152 stores the XHTML-Print data received from the XHTML-Print data generation unit 151 in a form of a file in the storage unit 120. The XHTML-Print data is stored with a file name having an extension of one of xml, htm, and html. Also, the data I/O unit 152 reads the XHTML-Print data from the storage unit 120.

The XHTML-Print data parsing unit 153 parses the XHTML-Print data received through the data I/O unit 152 from the storage unit 120. The parsed XHTML-Print data includes the layout information to be used to print the image. According to the present embodiment, the XHTML-Print data parsing unit 153 is shown to be included in the device 100. Here, the XHTML-Print data parsing unit 153 may be included in the image forming apparatus 110. In this case, the image forming apparatus 110 can parse the XHTML-Print data read from the storage unit 120.

The storage unit 120 may be a memory card to store image data so that the image data can be used in personal portable digital devices, such as a mobile phone and PDA, and a PC, and includes a smart media card, a compact flash memory, a memory stick, and secure digital (SD) memory. The storage unit may be a portable storage medium that can be detachably attached to the device 100 or the image forming apparatus 110, and can be attached to another device or image forming apparatus after being separated from the device 100. The storage unit 120 stores the XHTML-Print data in a form of a file and may store image data. The image data can be joint photographic experts group (JPEG) data, graphics interchange format (GIF) data, bitmap (BMP) data, and portable network graphics (PNG) data and tag image file format (TIFF) data.

In an embodiment of the present general inventive concept, the storage 120 can be embedded in the device 100 or the image forming apparatus 110. In this case, the storage unit 120 can be an internal memory such as a ROM and RAM, and a large capacity storage device such as the hard disk. When the storage unit 120 is a hard disk, the hard disk can be used after being separated from the device 100 and then attached to another device, like the portable storage medium.

FIG. 1B is a block diagram illustrating an image forming system using XHTML-Print data according to an embodiment of the present general inventive concept.

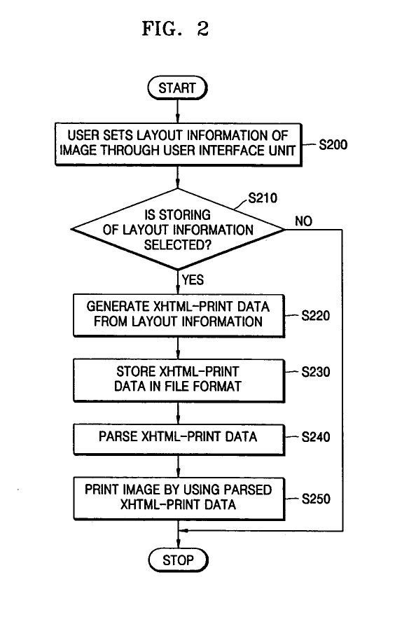

Referring to FIG. 2, the image forming system is formed with a device 200 and an image forming apparatus 110, and the device 200 communicates with another device 300 through a network 170.

The device 200 includes a storage unit 125, a user interface unit 130, a control unit 140, and an I/O interface unit 160.

The user interface unit 130 and the control unit 140 perform the same functions as the corresponding elements of the device 100 of FIG. 1A, and therefore the explanation will be omitted here.

The storage unit 125 stores XHTML-Print data and image data. The storage unit 120 can be a ROM, a RAM, and a large capacity storage device such as a hard disk.

The I/O interface unit 160 transmits the XHTML-Print data to the another device 300 through the network 170 under control of the control unit 140. The network 170 can be a wireless network, such as Bluetooth and an infrared data association (IRDA) network, or a wired network.

When an identical image is printed in an identical layout, the another device 300 prints the image by using the XHTML-Print data received through the network 170 without a need to reset layout information. The another device 300 can be a device identical to the device 100. In another embodiment, the another device 300 can be an image forming apparatus, a PC, or a server.

FIG. 2 is a flowchart illustrating an image forming method using XHTML-Print data according to an embodiment of the present general inventive concept, and will now be explained in association with the elements of FIG. 1A.

Referring to FIGS. 1A and 2, the user sets layout information of an image to be laid out in one page through the user interface unit 130 in operation S200.

The image can be formed with a plurality of pages. The layout of the image represents effectively laying out a plurality of images within a limited space. In particular, in order to print a plurality of images in one page, or in order to store the plurality of images in the form of an album by laying out in one page, an image layout application is used. First, by executing the image layout application, a plurality of image files are opened or generated. Then, if one of layout types in which the plurality of images are laid out is selected, the plurality of images are laid out according to the selected layout. At this time, the image layout can be prepared directly by the user.

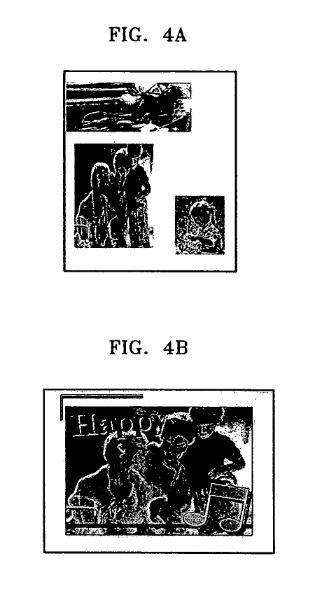

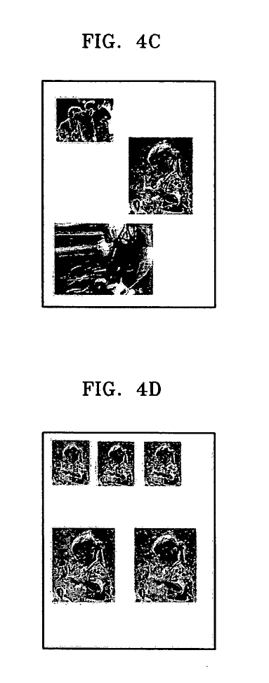

Also, the layout information includes image position information, image size information, print paper information, font information (only when there are text data), and space information. FIGS. 4A through 4D are diagrams showing examples of layout results of images.

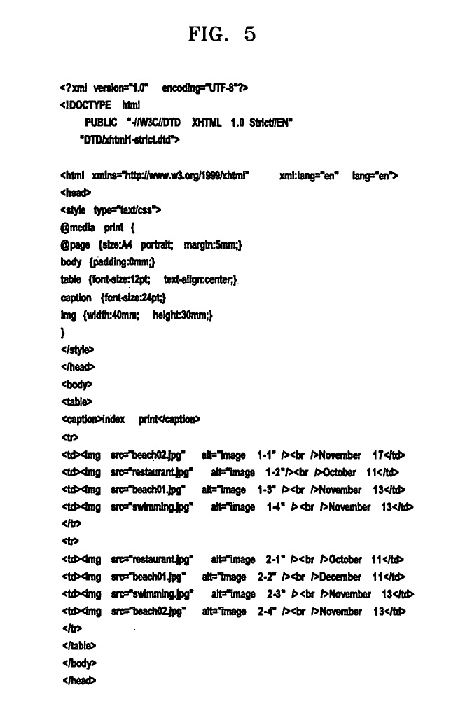

In operation S210, the control unit 140 determines whether or not storing of the layout information is selected by the user. If the storing of the layout information is not selected, the process is finished. If the storing of the layout information is selected, the XHTML-Print data generation unit 151 generates XHTML-Print data from the layout information received from the user interface unit 130 in operation S220. FIG. 5 is a view illustrating XHTML-Print data generated in the XHTML-Print data generation unit 151.

The data I/O unit 152 stores the XHTML-Print data which is generated in the XHTML-Print data generation unit 151, in a form of a file in the storage unit 120 in operation S230. At this time, if the user inputs a filename through the user interface unit 130, the XHTML-Print data is stored with the input filename. If the filename is not input, a default filename (for example, xhtmlprint1.html) is generated and stored.

The filename has any one extension among xml, htm, and html extensions.

In operation S240, the XHTML-Print data parsing unit 153 parses the XHTML-Print data received through the data I/O unit 152 from the storage unit 120.

According to the present embodiment, the XHTML-Print data parsing unit 153 is included in the device 100. However, the XHTML-Print data parsing unit 153 can be included in the image forming apparatus 110. In this case, the XHTML-Print data read from the storage unit 120 can be parsed in the image forming apparatus 110.

In operation S250, if the control unit 140 transmits the parsed XHTML-Print data to the image forming apparatus 110, the image forming apparatus prints the image by using the parsed XHTML-Print data. The parsed XHTML-Print data includes the layout information of the images to be printed within an area of a printing medium. When the XHTML-Print data parsing unit 153 is included in the image forming apparatus 110, the image forming apparatus 110 parses the XHTML-Print data and prints the image.

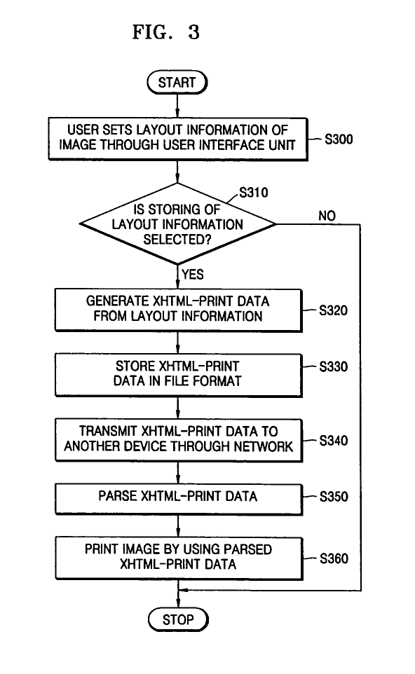

FIG. 3 is a flowchart illustrating an image forming method using XHTML-Print data according to an embodiment of the present general inventive concept, and will now be explained in association with the elements of FIG. 1B.

Referring to FIGS. 1B and 3, in operation S300, the user sets layout information of an image to be laid out in one page through the user interface unit 130. In operation S310, the control unit 140 determines whether or not storing of the layout information is selected by the user. If the storing of the layout information is not selected, the process is finished. If the storing of the layout information is selected, the XHTML-Print data generation unit 151 generates XHTML-Print data from the layout information received from the user interface unit 130 in operation S320. The data I/O unit 152 stores the XHTML-Print data generated in the XHTML-Print data generation unit 151, in the form of a file in the storage unit 120 in operation S330.

The operations S300 through S330 described above are the same as the operations S200 through S230 of FIG. 2 and the detailed explanation will be omitted here.

In operation S340, the I/O interface unit 160 transmits the XHTML-Print data through the network 170 to the another device 300 under control of the control unit 140. The network 170 can be a wireless network, such as Bluetooth and an infrared data association (IRDA) network, or a wired network. The another device 300 can be a device identical to the device 100. In another embodiment, the another device can be an image forming apparatus, a PC, or a server.

In operation S350, the another device 300 parses the XHTML-Print data received through the network 170. In operation S360, if the another device 300 transmits the parsed XHTML-Print data to another image forming apparatus, the another image forming apparatus prints the image by using the parsed XHTML-Print data. If the another device 300 is an image forming apparatus, the operation S360 is performed in the another device 300.

The operations S350 and S360 are similar to the operations S240 and S250 of FIG. 2. However, the parsing of the XHTML-Print data and printing using the data are not performed in the device 200, but performed in the another device 300 receiving the XHTML-Print data through the network 170.

According to the present invention, by writing layout information of an image in the XHTML-Print language and storing the information, when an identical image is to be printed in an identical layout, the image forming system can print the image by using the XHTML-Print data of the stored layout information without resetting the layout, information, thereby providing user with convenience.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming method of an image forming system having an image forming apparatus printing an image, and a device connected to the image forming apparatus, the image forming method comprising:
setting layout information of an image;
generating HXTML-Print data from the set layout information; and
storing the XHTML-Print data in a storage unit.

2. The method of claim 1, wherein the storing of the XHTML-Print data comprises:
parsing the XHTML-Print data and printing the image according to the parsed XHTML-Print data.

3. The method of claim 1, wherein the layout information comprises at least one of position information of a sub-image to be laid out in one page, image size information, print paper information, font information, and space information.

4. The method of claim 1, wherein the image comprises one or more images to be formed on one page or a plurality of pages.

5. The method of claim 1, wherein the storage unit comprises one of a storage medium detachably attachable to the image forming apparatus, a memory in the image forming apparatus, and a large capacity storage apparatus.

6. The method of claim 1, wherein the storing of the XHTML-Print data comprises parsing the generated XHTML-Print data to print the image according to the parsed XHTML-Print data, and storing the XHTML-Print data in the storage unit.

7. The method of claim 1, further comprising:
transmitting the XHTML-Print data stored in the storage unit to another device through a network.

8. The method of claim 7, wherein the transmitting of the XHTML-Print data comprises:
parsing the XHTML-Print data and printing the image according to the parsed XHTML-Print data.

9. The method of claim 7, wherein the layout information comprises at least one of position information of each sub-image of the image to be laid out in one page, image size information, print paper information, font information, and space information.

10. The method of claim 7, wherein the image comprises one or more image to be formed on one page or a plurality of pages.

11. The method of claim 7, wherein the storing of the XHTML-Print data comprises parsing the generated XHTML-Print data to print the image according to the parsed XHTML-Print data, and storing the XHTML-Print data in the storage unit.

12. The method of claim 7, wherein the transmitting of the XHTML-Print data comprises transmitting the XHTML-Print data to the another device through a wired network or a wireless network.

13. The method of claim 7, wherein the another device comprises one of an apparatus identical to the device or the image forming apparatus, a PC, and a server.

14. An image forming system using extensible hypertext markup language (XHTML)-Print data, the image forming system having an image forming apparatus printing an image, and a device connected to the image forming apparatus,
wherein:
the device comprises:
a user interface unit to set layout information of an image, and
a control unit to lay out the image according to the layout information, to generate XHTML-Print data from the layout information, to read and parse the XHTML-Print data, and to transmit the parsed XHTML-Print data to the image forming apparatus; and
the image forming system further comprises:
a storage unit to store the generated XHTML-Print data.

15. The system of claim 14, wherein the control unit comprises:
an image processing unit to lay out the image according to the layout information; and
an XHTML-Print data processing unit to generate the XHTML-Print data from the layout information, to store the XHTML-Print data in the storage unit, to read the XHTML-Print data from the storage unit, and to parse the XHTML-Print data to print the image.

16. The system of claim 15, wherein the XHTML-Print data processing unit comprises:
an XHTML-Print data generation unit to generate the XHTML-Print data from the layout information;
a data input/output unit to store the XHTML-Print data in the storage unit and to read the XHTML-Print data from the storage unit; and
an XHTML-Print data parsing unit to parse the XHTML-Print data.

17. The system of claim 14, wherein the layout information comprises at least one of position information of each sub-image of the image to be laid out in one page, image size information, print paper information, font information, and space information.

18. The system of claim 14, wherein the storage unit comprises one of a storage medium detachably attachable to the image forming apparatus, a memory in the image forming apparatus, and a large capacity storage apparatus.

19. An image forming system using extensible hypertext markup language (XHTML)-Print data, the image forming system having an image forming apparatus printing an image, and a device connected to the image forming apparatus, wherein the device comprises:
a user interface unit to set layout information of an image;
a control unit to lay out the image according to the layout information, to generate XHTML-Print data from the layout information, to read and to parse the XHTML-Print data, and to transmit the parsed XHTML-Print data to the image forming apparatus;
a storage unit to store the generated XHTML-Print data; and
an input/output interface unit to transmit the XHTML-Print data to another device through a network.

20. The system of claim 19, wherein the control unit comprises:
an image processing unit to lay out the image according to the layout information; and
an XHTML-Print data processing unit to generate the XHTML-Print data from the layout information, to store the XHTML-Print data in the storage unit, to read the XHTML-Print data from the storage unit, and to parse the XHTML-Print data.

21. The system of claim 20, wherein the XHTML-Print data processing unit comprises:
an XHTML-Print data generation unit to generate the XHTML-Print data from the layout information;
a data input/output unit to store the XHTML-Print data in the storage unit and to read the XHTML-Print data from the storage unit; and
an XHTML-Print data parsing unit to parse the XHTML-Print data.

22. The system of claim 19, wherein the layout information comprises at least one of position information of each sub-image of the image to be laid out in one page, image size information, print paper information, font information, and space information.

23. The system of claim 19, wherein the input/output interface unit transmits the XHTML-Print data to the another device through a wired network or a wireless network.

24. The system of claim 19, wherein the another device comprises one of an apparatus identical to the first device or the image forming apparatus, a PC, and a server.

25. An image forming system comprising:
a storage unit; and
a control unit to control the storage unit to store XHTML-Print data corresponding to layout information on a first image, and to read the stored XHTML-Print data from the storage unit to form a second image according to the read XHTML-Print data.

26. The system of claim 25, wherein the control unit determines whether the first image is identical to the second image.

27. The system of claim 25, wherein the control unit determines whether the first image and the second image have the same layout information.

28. The system of claim 25, wherein the control unit parses the XHTML-Print data such that the second image is formed according to the parsed XHTML-Print data.

29. The system of claim 25, further comprising:
a printing unit,
wherein the control unit controls the printing unit to print the first image and the second image according to the same XHTML-Print data.

30. The system of claim 25, further comprising:
a printing unit,
wherein the control unit receives the XHTML-Print data so that the storage unit stores the XHTML-Print data, and controls the printing unit to print the second image according to the read XHTML-Print data.

31. The system of claim 25, wherein the first image comprises one or more sub-images which is laid out in a predetermined printing medium according to the layout information, and the second image comprises one or more second sub-images which is laid out in a predetermined printing medium according to the layout information.

32. The system of claim 25, further comprising:
a user interface to set the layout information; and
an XHTML-Print data processing unit to generate the XHTML-Print data according to the set layout information.

33. An image forming system comprising:
a user interface unit to set layout information;
an XHTML-Print data processing unit to generate the XHTML-Print data according to the set layout information;
a storage unit;
a print unit; and
a control unit to control the print unit a first image according to the layout information, to generate XHTML-Print data using an XHTML language from the layout information so that a first image is printed according to the layout information, to store the XHTML-Print data in the storage unit, and to output the XHTML-Print data to an external device, to read and parse the XHTML-Print data, and to control the print unit to print a second image according to the parsed XHTML-Print data.

34. An image forming system comprising:
a first device comprising:
a user interface unit to set layout information,
an XHTML-Print data processing unit to generate the XHTML-Print data according to the set layout information,
a storage unit, and
a control unit to generate XHTML-Print data using an XHTML language from the layout information so that a first image is formed according to the XHTML-Print data, to store the XHTML-Print data in the storage unit, and to output the XHTML-Print data; and
a second device comprising:
a second storage unit,
a print unit, and
a second control unit to receive the output XHTML-Print data from the first device, to control the second storage unit to store the XHTML-Print data, to read and parse the XHTML-Print data, and to control the print unit to print a second image according to the parsed XHTML-Print data.
